(19) United States
(12) Patent Application Publication
(10) Pub. No.: US 2023/0241994 A1
(43) Pub. Date: Aug. 3, 2023

(54) METHOD FOR PLANNING CHARGING PROCESSES FOR AN ELECTRIC VEHICLE

(71) Applicant: MERCEDES-BENZ GROUP AG, Stuttgart (DE)

(72) Inventors: Frederic HERZOG, Stuttgart (DE); Frank HEPPERLE, Weil im Schönbuch (DE); Karl SCHWENK, Weil der Stadt (DE)

(21) Appl. No.: 18/011,894

(22) PCT Filed: Jun. 11, 2021
(86) PCT No.: PCT/EP2021/065818

§ 371 Date: Dec. 21, 2022

(30) Foreign Application Priority Data
Jun. 25, 2020 (DE) 10 2020 003 824.7

(51) Int. Cl. B60L 53/62; B60L 53/63; H02J 7/00; G06Q 10/0631

(52) U.S. Cl. CPC B60L 53/62; B60L 53/63; H02J 7/0071; G06Q 10/0631; B60L 2240/70

(57) ABSTRACT

A charging processes for an electric vehicle is planned depending on a future energy requirement of the electric vehicle, and a sequence of historical journeys and historical parking processes of the electric vehicle is taken into account when the future energy requirement is determined.

### BACKGROUND AND SUMMARY OF THE INVENTION

Exemplary embodiments of the invention relate to a method for planning charging processes for an electric vehicle.

A method for predicting driving situations is known from EP 1 741 591 B1, wherein a majority of standard driving situations are determined and a forthcoming route is assigned to a standard driving situation. A control of a battery charging cycle occurs depending on this allocation.

Exemplary embodiments of the invention are directed to a new method for planning charging processes for an electric vehicle.

In the method for planning charging processes for an electric vehicle, the planning is carried out depending on a future energy requirement of the electric vehicle, wherein a sequence of historical journeys and historical parking processes of the electric vehicle is taken into account when determining the future energy requirement.

The method enables future journeys and their energy requirement to be determined from the historical journeys and historical parking processes in a simple and reliable manner. A selection of suitable charging stops from a sequence of future parking or resting locations is consequently enabled. So-called grid-supportive charging and an optimized utilization of locally generated regenerative energies can thus be implemented.

The aspect of battery protection is simultaneously taken into account as a possible further goal for the planning of charging processes. The costs that are caused by battery ageing are thus minimized as far as possible.

In a possible embodiment of the method, a beginning of a charging time, a charging duration, and/or a charging location is/are determined in the planning of the charging processes. A journey of the electric vehicle and charging processes carried out during driving breaks can thus be aligned with each other and optimized.

In a further possible embodiment of the method, resting locations of the electric vehicle and a resting frequency of the electric vehicle at these resting locations are determined, wherein arrival probabilities and/or departure probabilities of the electric vehicle at or from the resting locations are provided from the resting locations and the resting frequency. The arrival probabilities and/or departure probabilities are taken into account when planning the charging processes.

In a further possible embodiment of the method, a respective parking duration of the electric vehicle is provided for the resting locations and taken into account when planning the charging processes. Knowledge of the parking or resting locations with a parking or dwelling duration at this location here enables, among other things, an automated use of so-called “opt in” charging possibilities and in further future markets.

In a further possible embodiment of the method, initial states are determined from the parking locations, and associated parking durations of the electric vehicle at a resting location are assigned to the initial states, wherein final states are formed from the initial states, which depict the respective resting location and the associated parking duration in a simple manner.

In a further possible embodiment of the method, contextual information is assigned to the initial states in the event of several different parking durations of the electric vehicle at a resting location and a predetermined difference between the parking durations being exceeded, such that these initial states can depict the respective resting location and the associated parking duration in a simple manner.

In a further possible embodiment of the method, the final states are entered in a transition matrix together with a state comprising all unknown states, wherein a prognosis chain, for example a so-called Markow chain, is determined from the transition matrix by means of a stochastic process. A transition prognosis is carried out by means of the prognosis chain, in which an arrival probability at parking or resting locations and a probability of in what sequence future journeys and parking processes are likely to occur are determined. This enables the probabilities, and thus an exact planning of the charging processes, to be determined particularly simply and reliably.

In a further possible embodiment of the method, an energy usage prognosis is carried out by means of the arrival probability and the probability of in what sequence future journeys and parking processes are likely to occur, wherein an energy usage determined here is taken into account when planning the charging processes. A future journey can thus be planned in a reliable manner depending on a determined energy usage and available charging possibilities at future parking or resting locations. This means that a strategy for charging processes to come can be determined, wherein this can occur in relation to an optimal charging location, an optimal charging time and an optimal charging duration. It can be convenient, for example, to select only as short a charging duration as possible, or a late charging time at which an energy price is cheaper and peak loads can be avoided. It can further be convenient to charge such that the one strategy that protects the battery as far as possible is followed. This can be achieved, for example, by extreme charging states, i.e., full charge (100%) and complete discharge (0%) already being substantially avoided in the planning, as they have a negative effect on the lifespan of the battery. The planning can additionally take into account that the battery charge level is always within a defined interval, for example between 20% and 80%, wherever possible.

### BRIEF DESCRIPTION OF THE DRAWING FIGURES

Exemplary embodiments of the invention are explained in more detail in the following with reference to the drawings.

Here:

FIG. 1 schematically shows factors influencing a charging process of an electric vehicle

FIG. 2 schematically shows a determination of arrival probabilities and departure probabilities of an electric vehicle from resting locations,

FIG. 3 schematically shows a sequence of a method for planning charging processes for an electric vehicle and

FIG. 4 schematically shows a transition matrix.

Parts corresponding to one another are provided with the same reference numerals in all figures.

### DETAILED DESCRIPTION

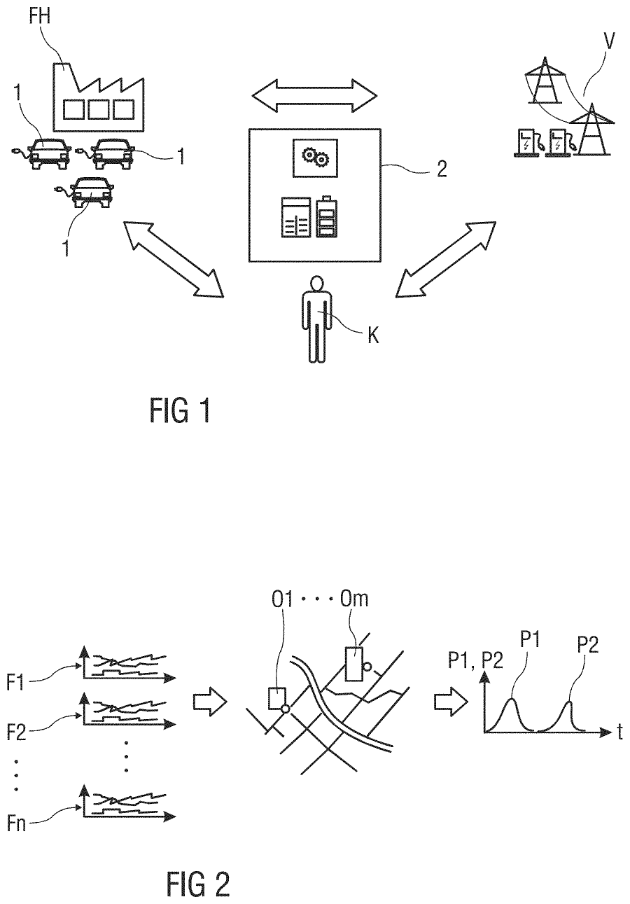

Factors influencing a charging process of an electric vehicle 1 are depicted in FIG. 1.

An interaction between vehicle manufacturers FH, customers K and energy providers V must be considered when charging electric vehicles 1. The energy provider V here attempts to avoid peak loads in energy consumption, and the customer K wants as high a level of mobility and flexibility as possible, alongside low energy costs. A long battery lifespan is desirable for a vehicle manufacturer FH.

In order to attain these goals, which at least partially deviate from one another, with the lowest possible degree of conflict, a charging assistance system 2 is provided, by means of which a method for planning charging processes for an electric vehicle 1 is carried out. The method enables the goals to be connected by an intelligent approach when charging the electric vehicle 1.

For this purpose, the planning is carried out depending on a future energy requirement of the electric vehicle 1, and a sequence of historical journeys F1 to Fn and historical parking processes of the electric vehicle 1 is taken into account when determining the future energy requirement. A beginning of a charging time, a charging duration and a charging location are here in particular determined when planning the charging processes.

FIG. 2 shows a determination of arrival probabilities P1 and departure probabilities P2 of an electric vehicle 1 or of resting locations O1 to Om depending on a time t.

Resting locations O1 to Om of the electric vehicle 1 and a resting duration of the electric vehicle 1 at these resting locations O1 to Om are here provided from the historical journeys F1 to Fn of the electric vehicle 1.

Arrival probabilities P1 and departure probabilities P2 of the electric vehicle 1 at or from the resting locations O1 to Om are determined from the resting locations and the resting frequency, wherein the arrival probabilities P1 and/or departure probabilities P2 are taken into account when planning the charging processes. Journeys and standstills for a future time horizon are predicted here.

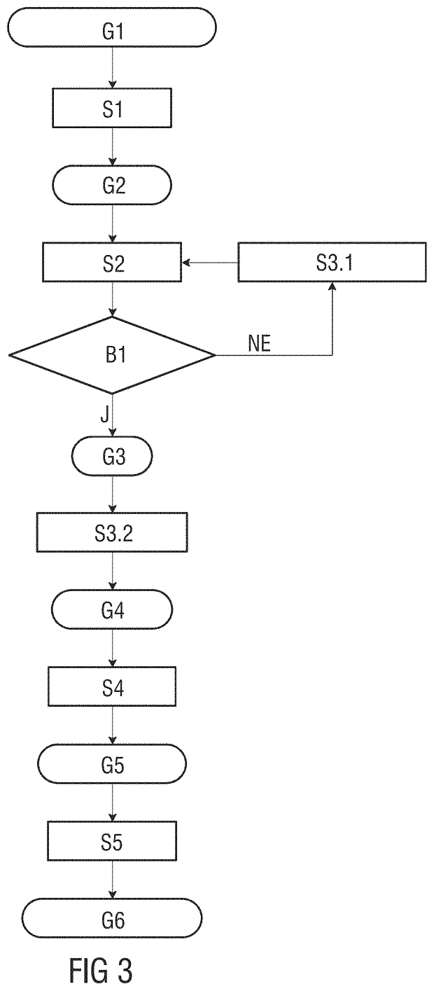

A sequence of a possible exemplary embodiment of a method according to the invention for planning charging processes for an electric vehicle 1 is depicted in FIG. 3.

Significant initial states G2 are provided here in a method step S1 on the basis of geodetic vehicle positions G1 by means of a cluster method. The historical geodetic vehicle positions G1 are provided from GPS data, for example, and in particular represent not the historical journeys F1 to Fn in themselves, but rather the beginning and end positions.

Geodetic vehicle positions G1 that cannot be assigned to a significant initial state G2 are combined under the state N.

An initial state G2 is here, in particular, understood as geodetic locations without limiting context. Initial states G2 are, for example, parking or resting locations O1 to Om that are often driven to by the electric vehicle 1, e.g., a home address, a place of work, frequently visited supermarkets, gyms, addresses of relatives, etc.

A dwelling duration for each initial state G2, i.e., a respective parking duration of the electric vehicle 1 for the resting locations O1 to Om is further provided in a further method step S2 by chronological assignment of the geodetic vehicle positions G1.

In a condition B1, it is checked whether a range of variation of the dwelling duration of each initial state G2, characterized by an interquartile spacing, is within a predetermined tolerance range, i.e., a predetermined maximum variation of the dwelling duration. When the condition B1 is satisfied, represented by a yes branch J, initial states G2 are transferred to final states G3. A final state G3 is, in particular, understood as a state that can be characterized by a limiting context. Several final states G3 are thus determined, which respectively combine an initial state G2 or location with a characteristic dwelling duration. Possible final states G3 can here be described as content, for example “home overnight”, “home on Saturday afternoon”, and “place of work on a working day”.

If the condition B1 is not satisfied, depicted by a no branch NE, such as, for example, if different dwelling durations are present at the same resting location O1 to Om, then initial states G2 are split into further initial states G2 by enrichment with contextual information, such as a day of the week or a season, for example, in a further method step S3.1, and added to the method step S2 in turn. This means that a resting location O1 to Om can have several final states G3 depending on dwelling duration.

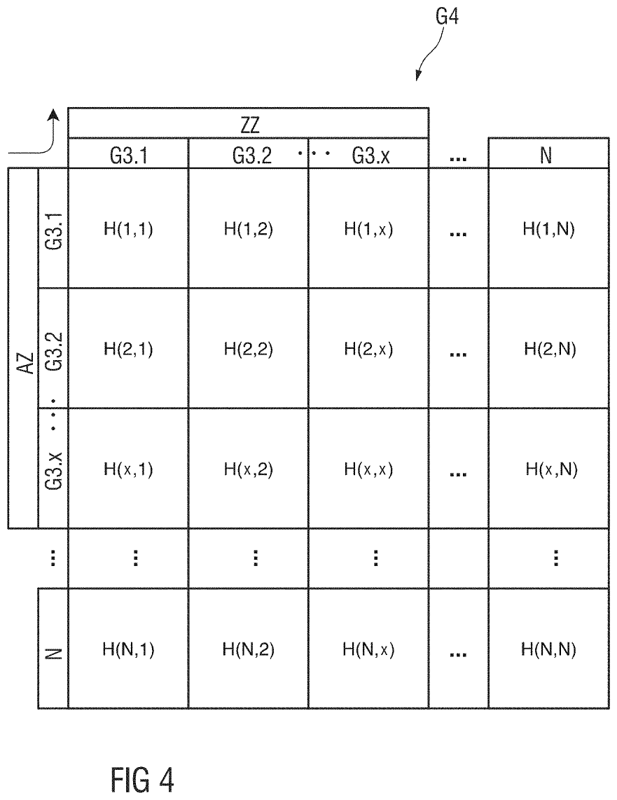

In a further method step S3.2, all pairs of final states G3 are determined by statistical evaluation of transition frequencies H depicted in more detail in FIG. 4 and stored in a transition matrix, also depicted in more detail in FIG. 4. The final states G3 are input here into the transition matrix G4 together with a state N comprising all unknown states. The transition frequency H here depicts a relative and/or absolute frequency of a transition between exactly two final states G3. A transition frequency H, for example, specifies how often a driver of the electric vehicle 1 travels between a final state G3 “home overnight” and a final state G3 “place of work on a working day”.

A transition prognosis G5 is created based on the transition matrix G4 in a further method step S4 by using a hypothetical beginning state. A prognosis chain is here provided from the transition matrix G4, in particular, by means of a stochastic process, and the transition prognosis G5 is carried out by means of the prognosis chain. The transition prognosis G5 here comprises the arrival probabilities P1 at resting locations O1 to Om, and in particular a probability of what sequence future journeys and placement processes will occur in, and thus makes a prediction of successive chronological state transitions with their relative and/or absolute frequency in a given output state.

An energy usage prognosis G6 is then determined in a further method step S5 based on the transition prognosis G5 by assigning a characteristic energy usage for each state transition, being weighted with the relative transition frequency H and a summation. This means that the energy usage prognosis G6 makes a chronological prediction of successive energy usages based on a sum of all transition prognoses G5 that are weighted with their relative or absolute frequencies. A strategy for charging processes to come can be determined by means of the energy usage prognosis G6, wherein this can occur in relation to an optimal charging location, an optimal charging time and an optimal charging duration. It can, for example, be convenient to select only a charging duration that is as short as possible, or a late charging time at which an energy price is cheaper, and peak loads can be avoided.

FIG. 4 shows a possible embodiment of a transition matrix G4, wherein several final states G3.1 to G3.x and respectively a state N to which all unknown states are assigned are assigned to an output state AZ and a goal state ZZ. The respective transition frequencies H are further input into the transition matrix G4 for the transitions between the final states G3.1 to G3.x, and between the final state G3.x and the state N.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method, comprising:
planning a charging processes for an electric vehicle by determining a future energy requirement of the electric vehicle, wherein a sequence of historical journeys and historical parking processes of the electric vehicle are accounted for in the determination of the future energy requirement.

12. The method of claim 11, wherein the planning of the charging process involves determining:
a beginning of a charging time
a charging duration, or
a charging location.

13. The method of claim 11, further comprising:
determining parking locations of the electric vehicle and a resting frequency of the electric vehicle at these resting locations using the sequence of historical journeys; and
determining arrival probabilities or departure probabilities of the electric vehicle at or from the resting locations using the parking resting and the resting frequency,
wherein the arrival probabilities or departure probabilities are accounted for during the planning of the charging processes.

14. The method of claim 13, wherein a respective parking duration of the electric vehicle is determined for the resting locations and is accounted for during the planning of the charging processes.

15. The method of claim 14, further comprising:
determining initial states from the resting locations, and assigning associated parking durations of the electric vehicle in a resting location to the initial states;
forming final states from the initial states.

16. The method of claim 15, wherein contextual information is assigned to the initial states in event of several different parking durations of the electric vehicle at a resting location and a predetermined difference between the parking durations being exceeded.

17. The method of claim 15, further comprising:
entering the final states into a transition matrix together with a state comprising all unknown states;
determining a prognosis chain from the transition matrix using a stochastic process; and
performing a transition prognosis using the prognosis chain, in which an arrival probability at resting locations and a probability of what sequence future journeys and parking processes are likely to occur in the sequence of future journeys are determined.

18. The method of claim 17, further comprising:
performing an energy usage prognosis using the arrival probability and a probability of what sequence future journeys and parking processes are likely to occur in the sequence of future journeys, wherein an energy usage determined accounted for in the planning of the charging processes.

19. The method of claim 11, wherein an energy price accounted for in the planning of the charging processes.

20. The method of claim 11, wherein a load of an electrical network provided for charging is accounted for in the planning of the charging processes.
